(19) United States
(12) Patent Application Publication
(10) Pub. No.: US 2006/0262478 A1
(43) Pub. Date: Nov. 23, 2006

(54) Surge protected broadband power line communication system

(76) Inventor: Nisar Chaudhry, Huntington Station, NY (US)

Correspondence Address: MORGAN & FINNEGAN, L.L.P., 3 World Financial Center, New York, NY, 10281-2101, US

(21) Appl. No.: 11/133,629

(22) Filed: May 20, 2005

(51) Int. Cl. H02H 9/06

(52) U.S. Cl. 361/119

(57) ABSTRACT

A surge protected broadband power line communication system is provided. The system includes a local module with a base unit and a remote module with an extension unit. Both modules include broadband surge suppressors adapted to be connected to an AC power line. The base and extension units are connected to the surge suppressors and transmit and receive broadband digital signals through the surge suppressors and over the AC power line. The local and remote modules also have RF isolator filters connected to the surge suppressors and surge protected AC outlets connected to the outputs of the isolator filters. The local module is connected to a source of broadband digital signals such as a cable modem. The system makes the cable modem available in every room in a home simply by plugging an extension unit into an outlet located in that room.

### FIELD OF THE INVENTION

This invention relates to an AC power line communication system. More particularly, the invention relates to a surge protected broadband AC power line communication system which is able to distribute broadband digital signals over the AC power lines in a home while protecting the system from overvoltage conditions on the AC power lines.

### BACKGROUND OF THE INVENTION

Power line communication systems are known in the art. These communication systems are used, for example, to facilitate telephonic communications in locations where little or no availability exists for dedicated telephone wires. At least one such system is known which incorporates limited overvoltage protection for AC outlets.

U.S. Pat. No. 6,055,435 provides a power line communication system for transmitting telephone signals over the AC power lines in a home. While the system provides surge protected AC outlets, the system does not provide surge protection for the base or extension units which incorporate the sensitive electronics for transmitting and receiving the telephone signals over the AC power lines. The surge suppressor shown in FIG. 4 of U.S. Pat. No. 6,055,435 employs high capacitance MOVs which would attenuate the RF signals on the AC power lines. As a result, the surge suppressor must be isolated from the base and extension units and AC power lines and cannot provide surge protection for the base and extension units. See FIG. 1 and column 3, lines 20-25.

Wireless broadband communication systems are also known. These systems are commonly referred to as “Wi-Fi.” They employ a wireless router connected to a cable modem and allow persons within the operating range of the router to access the internet from their computers. A problem exists with Wi-Fi in that criminals are now gaining access to unsecured Wi-Fi networks. This problem was the subject of a front page article in the Mar. 19, 2005 issue of The New York Times entitled “Growth of Wireless Internet Opens New Path for Thieves.” See pages A1 and A10.

### SUMMARY OF THE INVENTION

A need exists for a system which is capable of transmitting and receiving broadband digital information securely on AC power lines while, at the same time, providing overvoltage protection for the sensitive electronic components of that system.

It is an object of the present invention to provide a surge protected broadband power line communication system which does not suffer from the security defects of Wi-Fi.

It is also an object of the invention to provide a broadband power line communication system which provides overvoltage protection for the sensitive electronics in the base and extension units.

It is a further object of the invention to provide a broadband surge suppressor which is capable of providing overvoltage protection for the sensitive electronics in the base and extension units without significantly attenuating the RF signals being transmitted and received by those units through the broadband surge suppressor and over the AC power lines.

It is a still further object of the invention to provide a broadband power line communication system with surge protected AC outlets which are isolated from the RF signals on the AC power lines while, at the same time, providing overvoltage protection for the sensitive electronics in the base and extension units.

The present invention overcomes the above-mentioned problems and other limitations of the background and prior art and achieves the above-mentioned objectives by providing a surge protected broadband power line communication system that comprises a local module with a base unit and a remote module with an extension unit. Both modules include broadband surge suppressors adapted to be connected to an AC power line. The base and extension units are connected to the surge suppressors and transmit and receive broadband digital signals through the surge suppressors and over the AC power line. The local and remote modules also have RF isolator filters connected to the surge suppressors and surge protected AC outlets connected to the outputs of the isolator filters.

It will be appreciated by those skilled in the art that the foregoing brief description and the following detailed description are exemplary and explanatory of this invention, but are not intended to be restrictive thereof or limiting of the advantages which can be achieved by this invention. Thus, the accompanying drawings, referred to herein and constituting a part hereof, illustrate preferred embodiments of this invention, and, together with the detailed description, serve to explain the principles of this invention.

### BRIEF DESCRIPTION OF THE DRAWINGS

Additional aspects, features, and advantages of the invention, both as to its structure and operation, will be understood and will become more readily apparent when the invention is considered in the light of the following description made in conjunction with the accompanying drawings, wherein:

FIG. 1 is a functional block diagram of an embodiment of the surge protected broadband power line communication system of the present invention.

FIG. 2 is a schematic diagram of an embodiment of the broadband surge suppressor portion of the present invention.

FIG. 3 is a schematic diagram of an embodiment of the RF isolator filter portion of the present invention.

FIG. 4 is a functional block diagram of an embodiment of the base and extension units of the present invention.

### DETAILED DESCRIPTION OF THE INVENTION

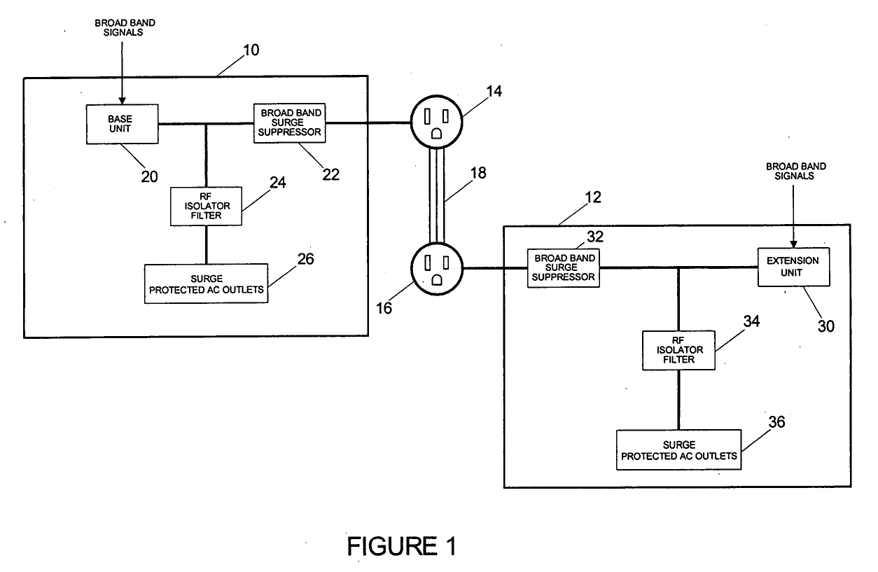

The surge protected broadband power line communication system of the present invention is shown in block diagram form in FIG. 1. The invention utilizes local module 10 and remote module 12. These modules are preferably plugged into AC outlets 14 and 16, respectively, (although they could be hard wired) and communicate with each other over AC power line 18 located, for example, within a home. Local module 10 includes broadband surge suppressor 22 which is adapted to be electrically connected to the AC power line by, for example, outlet 14. Remote module 12 contains an identical broadband surge suppressor 32 adapted to be electrically connected to the AC power line by, for example, outlet 16. In local unit 10, base unit 20 and RF isolator filter 24 are both electrically connected to surge suppressor 22. In remote unit 12, extension unit 30 and RF isolation filter 34 are both electrically connected to surge suppressor 32. The base and extension units may be identical and the RF isolator filters may be identical. In local unit 10 and in remote unit 12, electrical outlets 26 and 36 are connected to RF isolator filters 24 and 34, respectively. The RF isolator filters block the RF signals on the AC power lines from appearing at the surge protected AC outlets in the local and remote modules.

The base unit may be connected (e.g. by an RJ 45 jack) to a source of broadband digital signals such as a cable modem, or a satellite TV antenna or voice over intent protocol (VoIP) signals. The extension unit may be connected (e.g. by an RJ 45 jack) to devices which utilize broadband digital signals such as a computer or a TV set top box. The system of the present invention effectively provides an internal ethernet connection over AC power line 18. It is significant that, in the system shown in FIG. 1, the RF signals produced by the base and extension units are transmitted through the surge suppressors and over the AC power line. This is possible because the surge suppressor is a low capacitance (broadband) device. As a result, the surge suppressors can also provide overvoltage protection for the sensitive electronics in the base and extension units.

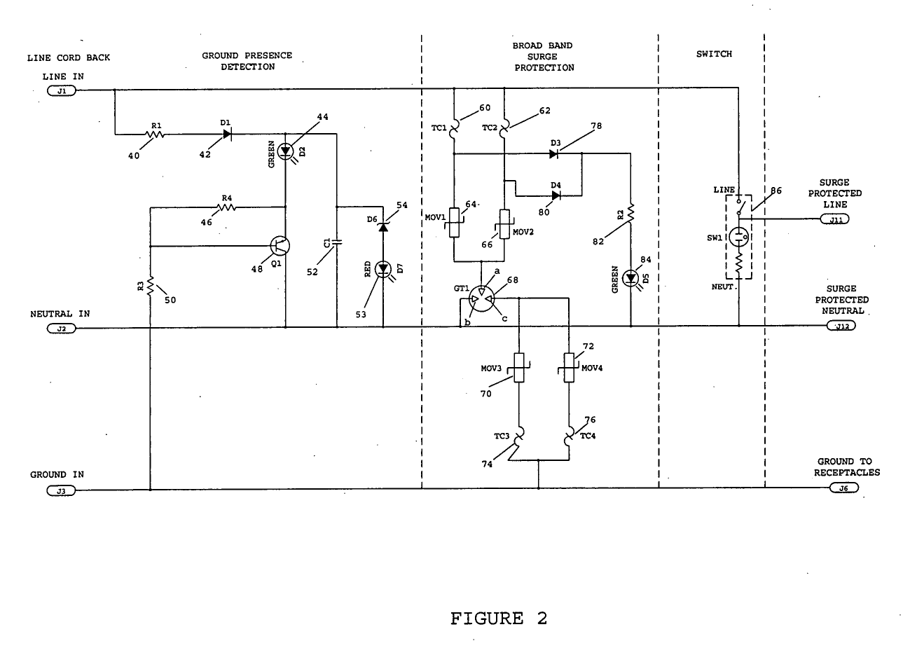

FIG. 2 is a schematic diagram of the broadband surge suppressor portion of the preferred embodiment of the present invention. The surge suppressor has three sections: (1) a first section which detects the presence or absence of the ground; (2) a second section which provides the actual surge protection; and (3) a third section comprising an ON/OFF switch with an indicator which provides a visual indication when the power is on. In the first section, the ground is detected by transistor 48 which is turned on when the ground is present, causing green LED 44 to be illuminated. If the ground is missing, transistor 48 will be off and red LED 53 will be illuminated, alerting the user to the fact that the ground is missing.

Surge protection is provided by a three electrode gas discharge tube 68 in combination with metal oxide varistors (MOVs) 64, 66, 70 and 72. The gas discharge tube (GDT) presents a very high impedance to RF signals on the AC power lines because the GDT has very low capacitance. This is in contrast to MOVs, which have significantly higher capacitance and would, in the absence of the GDT, attenuate the RF signals on the AC power lines. The surge protection circuit shown in FIG. 2 has one GDT electrode pair (a, b) electrically connected between AC line and AC neutral, a second GDT electrode pair (a, c) electrically connected between AC line and ground, and a third GDT electrode pair (b, c) electrically connected between AC neutral and ground. Although the preferred embodiment uses a single three electrode GDT to provide the three GDT electrode pairs, persons skilled in the art will readily appreciate that three two electrode GDTs could be used to provide the three GDT electrode pairs and that such an arrangement would be equivalent to using a single three electrode GDT. If three two electrode GDTs were used, one GDT would be electrically connected between AC line and AC neutral, one GDT would be connected between AC line and ground and one GDT would be connected between AC neutral and ground. Whether a single three electrode GDT is used or whether three two electrode GDTs are used there would be one GDT electrode pair electrically connected between AC line and AC neutral, one GDT electrode pair connected between AC line and ground and one GDT electrode pair connected between AC neutral and ground. In addition to GDT 68, surge protection is provided by MOVs 64, 66 which are connected between AC line and GDT 68, and by MOVs 70, 72, which are connected between GDT 68 and ground. Thermal overload protection is provided by thermal cutouts 60, 62, 74 and 76. In the preferred embodiment, GDT 68 has a breakdown voltage between 200 and 300 volts, while MOVs 64, 66, 70 and 72 have a breakdown voltage of on the order of 90 volts.

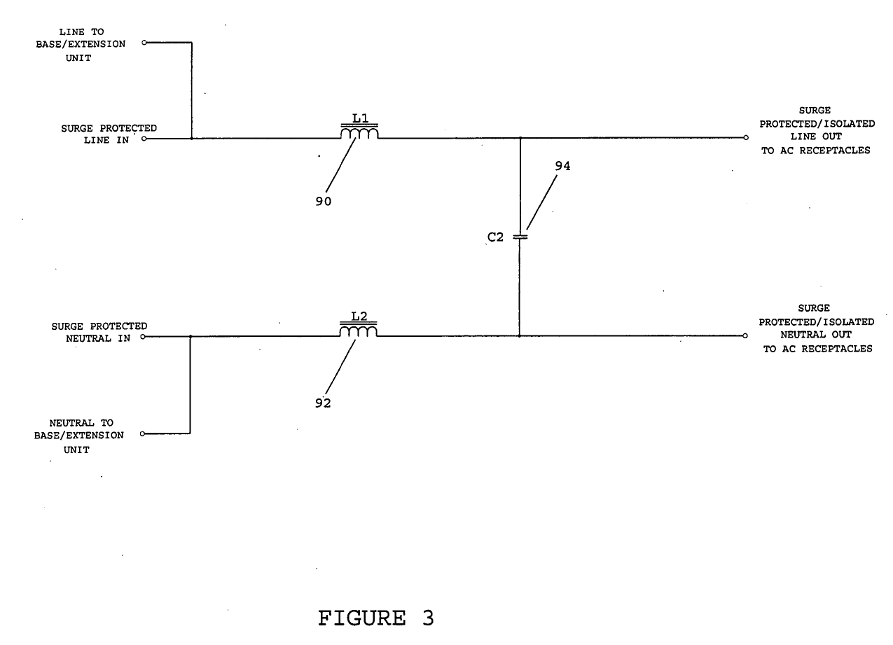

FIG. 3 is a schematic diagram of the RF isolator filter. It comprises inductors 90 and 92 and capacitor 94. These components form a low pass filter which blocks the passage of the RF signals appearing on the surge protected AC line and neutral, while permitting the 60 Hertz AC power to pass to the surge protected AC outlets.

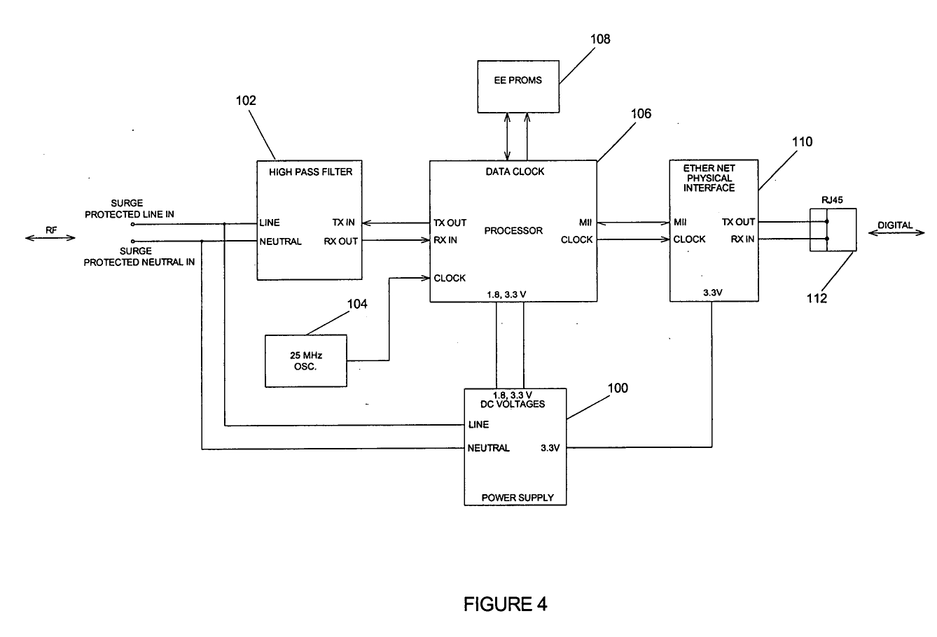

FIG. 4 is a functional block diagram of the base or extension unit of an embodiment of the present invention. It comprises power supply 100 which provides the regulated DC voltages required by the integrated circuits which perform the signal processing. The base or extension unit has a high pass filter 102 which is connected to the AC power line and couples the broadband RF signals on the AC power line to processor 106 while, at the same time, blocking the 60 Hertz AC signals. A 25 MHz oscillator 104 is connected to processor 106 and functions as the system clock. Also connected to processor 106 are electrically erasable programmable read only memory devices (EEPROMs) 108. Connected between processor 106 and RJ45 jack 112 is ethernet physical layer interface 110. The RJ45 jack is connected to a device such as a cable modem or the network interface card of a computer which transmits and receives broadband digital signals.

In the preferred embodiment of the invention, EEPROMs 108 are three-wire serial devices made by Atmel Corporation, 2325 Orchard Parkway, San Jose, Calif. 95131. In particular, preferred EEPROMs are Atmel AT93C46 devices. The Atmel website is www.atmel.com. In the preferred embodiment, the ethernet physical layer interface is made by Micrel Semiconductor, 2180 Fortune Drive, San Jose, Calif. 95131. In particular, the preferred Micrel ethernet physical layer interface is Micrel KS8721SL. The Micrel website is www.micrel.com. In the preferred embodiment, the preferred processor is made by Intellon Corporation, 5100 West Silver Springs Blvd., Ocala, Fla. 34482. In particular, the preferred processor is the Intellon INT5200 Single Chip PowerPacket™ Transceiver. The Intellon website is www.intellon.com.

Each local module 10 and each remote module 12 has a unique “MAC” number assigned to it. The same is true of each cable modem and each computer network interface card. MAC is sometimes (incorrectly) referred to as Media Access Control but the correct term is Medium Access Control. See Newton's Telecom Dictionary, 16 Edition, for a full explanation of MAC. Digital signals arriving at RJ45 112 are in packet form and contain the MAC address of the local or remote module. Ethernet physical layer interface 110 supports an MII (Media Independent Interface) which facilitates communication with processor 106. As explained in Newton's Telecom Dictionary, the MII is part of the Fast Ethernet specification and is used to connect the MAC layer to the physical layer. The processor in base unit 20 changes the MAC address in the incoming digital signals to that of extension unit 30 and converts the incoming digital signals to RF signals which are then placed on the AC power line. If extension unit 30 is connected to the network interface card in a computer and the computer user desires to send an e-mail over the internet, the extension unit receives the packets of digital information from the computer containing the MAC number of the extension unit, the extension unit changes the MAC number to that of the base unit and converts the digital signals from the computer to RF signals which are then placed on the AC power line which, as noted earlier, forms a local area network (LAN).

Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. It is therefore intended that the present invention is not limited to the disclosed embodiments but should be defined in accordance with the claims that follow.

What is claimed is:

1. A local or remote module for a surge protected broadband power line communication system, the module comprising:
a broadband surge suppressor adapted to be electrically connected to an AC power line; and
a base or extension unit electrically connected to the surge suppressor for transmission and receipt of broadband digital signals through the surge suppressor and over the AC power line.

2. A module according to claim 1, wherein the broadband surge suppressor comprises a gas discharge tube electrode pair electrically connected between the AC line and AC neutral, a gas discharge tube electrode pair electrically connected between AC neutral and ground and a gas discharge tube electrode pair electrically connected between the AC line and ground.

3. A module according to claim 2, wherein the module further comprises:
an RF isolator filter having an input connected to the surge suppressor to isolate the broadband signals being transmitted over the AC power line from output of the filter; and
at least one surge protected AC outlet electrically connected to the output of the RF isolator filter.

4. A module according to claim 2, wherein the gas discharge tube electrode pairs are contained within a single three electrode gas discharge tube.

5. A module according to claim 2, wherein the gas discharge tube electrode pairs are contained within three two electrode gas discharge tubes.

6. A module according to claim 4, wherein the broadband surge suppressor further comprises at least one MOV connected between the gas discharge tube and the AC line and at least one MOV connected between the gas discharge tube and ground.

7. A module according to claim 2, wherein the broadband surge suppressor further comprises a ground sensing circuit which provides a visual indication of presence or absence of the ground.

8. A module according to claim 2, wherein the broadband surge suppressor further comprises a switch which provides a visual indication when power is on.

9. A module according to claim 2, wherein the gas discharge tube electrode pairs have a breakdown voltage between 200 and 300 volts.

10. A module according to claim 6, wherein the MOV has a breakdown voltage of about 90 volts.

11. A surge protected broadband power line communication system, comprising:
a local module having a first broadband surge suppressor adapted to be electrically connected to an AC power line and a base unit electrically connected to the first surge suppressor for transmission and receipt of broadband digital signals through the first surge suppressor and over the AC power line; and
a remote module having a second broadband surge suppressor adapted to be electrically connected to an AC power line and an extension unit electrically connected to the second surge suppressor for transmission and receipt of broadband digital signals through the second surge suppressor and over the AC power line.

12. The system according to claim 11, wherein the first and second broadband surge suppressors comprise a gas discharge tube electrode pair electrically connected between the AC line and AC neutral, a gas discharge tube electrode pair electrically connected between AC neutral and ground and a gas discharge tube electrode pair electrically connected between the AC line and ground.

13. The system according to claim 11, wherein the local and remote modules further comprise:
an RF isolator filter having an input connected to the surge suppressor to isolate the broadband signals being transmitted over the AC power line from output of the filter; and
at least one surge protected AC outlet electrically connected to the output of the RF isolator filter.

14. The system according to claim 12, wherein the gas discharge tube electrode pairs are contained within a single three electrode gas discharge tube.

15. The system according to claim 12, wherein the gas discharge tube electrode pairs are contained within three two electrode gas discharge tubes.

16. The system according to claim 14, wherein the first and second broadband surge suppressors further comprise at least one MOV connected between the gas discharge tube and the AC line and at least one MOV connected between the gas discharge tube and ground.

17. The system according to claim 12, wherein the first and second broadband surge suppressors further comprise a ground sensing circuit which provides a visual indication of the presence or absence of the ground.

18. The system according to claim 12, wherein the first and second broadband surge suppressors further comprise a switch which provides a visual indication when power is on.

19. The system according to claim 12, wherein the gas discharge tube electrode pairs have a breakdown voltage between 200 and 300 volts.

20. The system according to claim 16, wherein the MOV has a breakdown voltage of about 90 volts.

21. The system according to claim 11, wherein the base and extension units are identical.
